(19) United States
(12) Patent Application Publication
(10) Pub. No.: US 2019/0239581 A1
(43) Pub. Date: Aug. 8, 2019

(54) THERMOPLASTIC PERSONAL PROTECTION EQUIPMENT

(71) Applicant: VIRTUS, SAINT JEAN DE NIOST (FR)

(72) Inventors: Mathieu Patrick RAT, SAINT JEAN DE NIOST (FR); Thibault Francois NIEDDU, LYON (FR)

(21) Appl. No.: 16/318,145

(22) PCT Filed: Jul. 26, 2017
(86) PCT No.: PCT/FR2017/052088

§ 371 Date: Jan. 16, 2019

(30) Foreign Application Priority Data
Jul. 28, 2016 (FR) 1657292

(51) Int. Cl. A41D 13/05; A63B 71/12; A01K 13/00

(52) U.S. Cl. CPC A41D 13/0543; A63B 71/1225; A01K 13/007; A63B 2071/1258; A41D 2500/50; A63B 2209/023; A41D 2500/20; A41D 2600/10; A63B 2243/0025

(57) ABSTRACT

An item of personal protective equipment (10) intended to protect a limb of an individual includes a main plate (12) of thermoplastic polymer material having two opposing faces, respectively an outer and an inner face, a first outer layer (18) placed next to the outer face of the main plate (12), and an inner shock-absorbing layer (20) arranged on the side of the inner face of the main plate (12). The first outer layer (18) is made of a textile material and is inlaid in the outer face of the main plate (12) so as to create, in the outer face, an impression of the textile material.

The invention concerns an item of personal protective equipment intended to protect a limb of an individual, human or animal.

The invention will be more particularly described in the context of an item of personal protective equipment intended to protect a leg of an individual. In a preferred application, this personal protective equipment is intended to protect the individual in the context of the practice of a sports activity.

According to a preferred application, the invention concerns a shin guard for a human being. According to another preferred application, the invention concerns an item of personal protective equipment for protecting the shin bone or a phalange of a fore or hind limb of an animal, notably a horse.

There are many activities in which it is useful to protect, at least to some extent, at least one portion of the limbs of an individual against impacts which, in the absence of any protection, could cause injury to the tissues of the limb, notably the skin and the muscles, or to the underlying bone of this limb.

In the field of human sports activities, shin guards are known to be used notably in soccer, skiing, mountain biking, roller skating, or motocross. In some of these sports, protections are also sometimes used for protecting the elbows or the forearms of the individual.

In all cases, these items of personal protective equipment must be worn by the individual and must therefore be, as far as possible, suited to their morphology, while ensuring their primary function which is to protect against impacts.

Document WO-01/12109 discloses a shin guard that can be made to fit the shape of the user's shin. This shin guard comprises a main plate, the material of which is initially flexible and may thus be made to fit the shape of the shin by the users themselves. In contact with air, notably by reaction with the moisture contained in the air, the material undergoes a chemical reaction by which it becomes irreversibly rigid.

Document WO-2012/037529 notably discloses a shin guard that can also be made to fit to the shape of the user's shin. This shin guard comprises a core made of thermoplastic material which can be made to fit the shape of the shin, but which is covered on both its inner and outer faces, by a rigid structure which is, for example, produced in the form of an aramid or carbon fiberglass fabric, embedded in a resin e.g. an epoxy resin. This rigid structure is therefore not thermoformable. It is understood from this document that the core of thermoplastic material is intended to take the impression of the anatomical shape of the limb to be protected, and that this shape is used to fit the rigid structures assembled on the inner and outer faces of the core. It is therefore understood that, although shaping the core may be performed multiple times, the protective equipment, once provided with its rigid structures may no longer be reshaped.

The invention therefore aims to provide an item of personal protective equipment intended to protect the limb of an individual, human or animal, that can be made to fit, optionally multiple times, without the need for tools or special equipment.

To do this, the invention provides for an item of personal protective equipment intended to protect a limb of an individual, comprising:

a main plate of thermoplastic polymer material having two opposing faces, respectively an outer and an inner face;

a first outer layer placed next to the outer face of the main plate; and

an inner shock-absorbing layer arranged on the side of the inner face of the main plate.

The first outer layer consists of a textile material and is inlaid in the outer face of the main plate so as to create, in the outer face, an impression of the textile material.

According to other optional features, taken alone or in combination:

The first outer layer may be applied against the outer face of the main plate by application under pressure and under a temperature sufficient to create an impression of the textile material in the outer face.

The textile material of the first outer layer may be a woven material.

The textile material of the first outer layer may be a fiberglass fabric.

The first outer layer may be covered, on an outer face opposite an inner face inlaid in the outer face of the main plate, with a polymer film.

The grammage of the polymer film may be less than 250 grams per square meter, preferably less than or equal to 150 grams per square meter.

The polymer film may be deposited by coating.

The polymer film may be a preformed film affixed with adhesion to the outer face of the first outer layer, notably by laminating.

The thermoplastic polymer material of the main plate may be thermoformable at less than 80° C.

The equipment is preferably capable of being shaped by passing from a first stable geometric configuration of the equipment, to a second stable geometric configuration of the equipment, distinct from the first, by heating by means of liquid hot water only, by applying a shaping force then by cooling. In this context the shaping force is preferably capable of being applied manually.

Preferably, the equipment is capable of being successively shaped multiple times.

The thermoplastic polymer material of the main plate may have a Vicat softening temperature, determined by the standard ISO 306:2013, method B50 using a load of 50 N and a heating rate of 50 K/h, which is less than 80° C., preferably less than 70° C. and more preferably less than 65° C., but preferably greater than 45° C.

The thermoplastic polymer material of the main plate may comprise a polycaprolactone type polyester and/or at least a polymer including polycaprolactone type macromolecular blocks.

The thermoplastic polymer material of the main plate may comprise a thermoplastic polyurethane including flexible segments of the polycaprolactone copolyester type.

The main plate may have a thickness of between 2 mm and 5 mm, and preferably between 2.5 mm and 4 mm.

The inner shock-absorbing layer may comprise a plate of cellular polymer material. A plate of cellular materials may comprise multiple layers of cellular polymer materials, optionally different cellular polymer materials, having different mechanical characteristics. Interlayer materials may also be used.

The main plate has a peripheral edge and perhaps an added bias astride the peripheral edge.

The bias may be sewn with a seam which passes through the main plate perpendicular to its inner and outer faces.

The bias may be a molded part, notably by plastic injection.

Various other features emerge from the description made below with reference to the appended drawings, which depict embodiments of the object of the invention by way of non-restrictive examples.

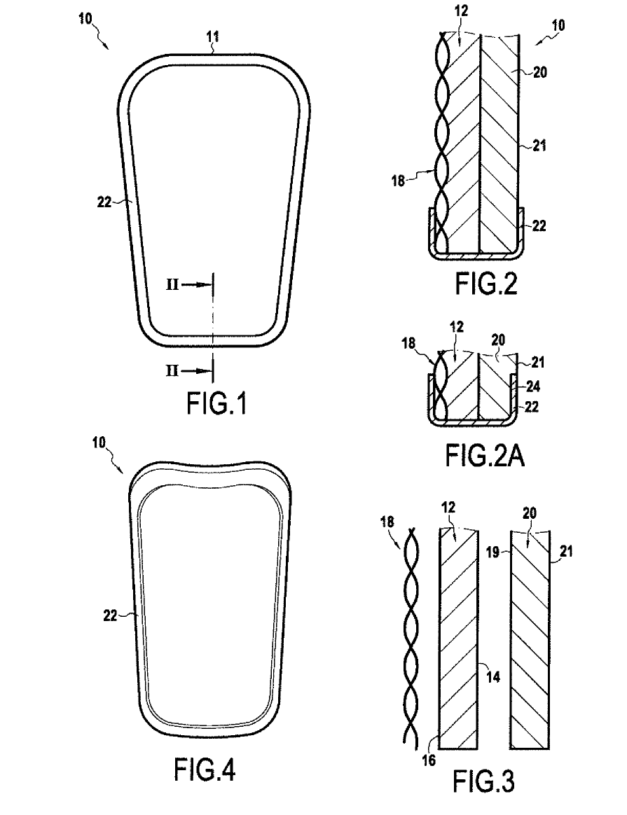

FIG. 1 illustrates a front view of an item of personal protective equipment according to the invention, illustrated before its shaping.

FIGS. 2 and 2A illustrate two variant embodiments in a partial cross-sectional view, at an edge, of the equipment in FIG. 1.

FIG. 3 illustrates an exploded schematic cross-sectional view of the various components of the equipment.

FIG. 4 illustrates a perspective schematic view of the personal protective equipment in FIG. 1, after its shaping according to a non-planar geometry.

A preferred embodiment of the invention will be described below in the context of the production of an item of personal protective equipment, hereinafter referred to as equipment, of the shin guard type, intended to be used by a human being in the practice of a sport, e.g. soccer.

In the embodiment, an item of equipment 10 is produced in an initially plane shape, illustrated in FIG. 1 and is intended to be shaped by the individual wishing to use this equipment 10 to impart a non planar geometry thereto as illustrated in FIG. 4. This non-planar geometry, for a shin guard, fits the geometry of the leg of an individual, notably of the lower portion located above the ankle and below the knee.

In FIG. 1, the equipment 10 therefore has the initial shape, before shaping, of a substantially plane element with a peripheral outline 11.

The shape illustrated in this figure is a shape well suited to the production of a shin guard, but other shapes are capable of being used for an item of equipment according to the invention, including if it is intended to form a shin guard. In the case of a shin guard, the equipment may, for example, for a small size, have a height in the direction of extension of the limb of 14 cm, and a maximum transverse width in the perpendicular direction of 10 cm. For larger sizes, the height may reach 20 cm and width may reach 13 cm. Of course, for other personal protective equipment, dimensions will be provided appropriate to the function.

As can be seen in FIGS. 2 and 3, the equipment 10 essentially comprises a main plate 12 which has two opposing faces which are arbitrarily referred to as the inner face and outer face. The inner face 14 is intended to face towards the limb to be protected. The outer face 16 is intended to face away from the limb to be protected.

As will be described in more detail later, the equipment 10 further comprises a first outer layer 18 placed next to the outer face of the main plate 12, and an inner shock-absorbing layer 20 which is arranged on the side of the inner face of the main plate 12.

The main plate 12 is made of thermoplastic polymer material. The thermoplastic polymer material refers to a material with a certain rigidity for a range of ambient temperatures, corresponding to the temperatures of the ambient atmosphere in normal conditions of use, this range of ambient temperatures being less than the Vicat softening temperature of the material. The thermoplastic polymer material has a malleable plastic state in an intermediate temperature range for shaping, above the Vicat softening temperature of the material, this in a reversible manner. Such a material regains its initial rigidity when the material is brought back into the range of ambient temperatures, below the Vicat softening temperature of the material, but may be brought back again at least a second time, into its malleable plastic state by being brought back again into the intermediate temperature range for shaping, above the Vicat softening temperature of the material.

Such a material is therefore not significantly thermally degraded when it is brought into the intermediate temperature range. With such a material, the mechanical shear stresses introduced by a shaping method do not significantly modify the molecular structure of the material when the shaping is performed in this intermediate shaping range.

The thermoplastic polymer material of the main plate 12 is at least semi-rigid, preferably rigid, at ambient temperature, notably at 20° C., and retains this semi-rigid or rigid character preferably up to at least 40° C., more preferably at least 45° C.

It is considered that a polymer material is semi-rigid at a given temperature if its tensile modulus of elasticity determined at this temperature according to the standard ISO 527-1:2012 is greater than 70 MPa, and it is rigid if its tensile modulus of elasticity determined at this temperature according to the standard ISO 527-1:2012 is greater than 700 MPa.

By virtue of the thermoplastic character of the polymer material composing it, the main plate 12 may be shaped by thermoforming. This shaping of the main plate corresponds to a shaping of the equipment 10. This shaping of the equipment 10 consists in passing from a first stable geometric configuration of the equipment 10, to a second stable geometric configuration of the equipment 10, distinct from the first. A stable geometric configuration of the equipment 10 corresponds to a geometric shape that the equipment 10 retains over time when it is not subject to any external stress. The first stable geometric configuration of the equipment 10 is, for example, a plane geometric configuration. The second stable geometric configuration is, for example, a geometric configuration in which the equipment 10 follows the shape of a portion of a limb of an individual, e.g. the shape of the front of the leg of a user. Thermoforming corresponds to a shaping in the course of which the element to be thermoformed is heated up to reach a malleable plastic state in an intermediate temperature range for shaping to allow its shaping, then cooled so that the shaping may be retained over time.

Advantageously, the thermoplastic polymer material of the main plate 12 is chosen to allow the thermoforming of the equipment 10 by a user, without requiring any tool specifically dedicated to this shaping, notably without requiring a rigid mold. For this, it is advantageous to choose the thermoplastic polymer material such that it allows shaping by thermoforming of the main plate 12 under a temperature of less than 80° C., e.g. between 50° C. and 80° C. The temperature reached is considered here in the core of the material of the main plate 12. The material must therefore be malleable in these conditions.

Such a choice notably makes it possible, for the purpose of thermoforming, for the equipment 10 to be heated by a very simple means, namely, for example, by hot liquid water, e.g. boiling water. Preferably, the hot liquid water is the only heat input used for shaping the equipment 10. The use of hot liquid water, notably boiling water, is particularly simple since its temperature is perfectly controlled without it being necessary to use a monitoring device for this, not even a thermometer. Assuming the use of hot liquid water, notably boiling water, for heating for the purpose of thermoforming, the fact of providing that the material is thermoformable at a temperature of less than 80° C. makes it possible to take into account the inevitable cooling of the material between the moment that it is heated and the moment that it is shaped. Indeed, the ideal case is to allow shaping of the equipment 10 directly in contact with the individual's limb in order thus to best follow the actual morphology of the individual's limb. In addition, the choice of a thermoforming temperature of less than 80° C. limits the risk of scalding.

Thus, the equipment 10 is capable of being shaped by passing from a first stable geometric configuration of the equipment 10, to a second stable geometric configuration of the equipment 10, distinct from the first, by heating by means of liquid hot water only, by applying a shaping force then by cooling.

Of course the shaping force is capable of being applied manually. This shaping force may be applied via a bandage or a sheath applied around the equipment, the latter being previously heated with liquid hot water and placed against the limb to be protected. The bandage or the sheath is, for example, applied manually. The bandage or the sheath help maintain the shaping force during the cooling of the equipment 10, therefore the cooling of the main plate 12, while the main plate 12, and therefore the equipment 10, is set in the desired geometrical configuration, corresponding, for example, to that of the limb against which it is placed. The bandage or the sheath also help to have a good distribution of the shaping force throughout the surface of the equipment 10.

Advantageously, the main plate 12, and therefore the equipment 10 is capable of being successively shaped multiple times.

The person skilled in the art is able to find many commercially available materials capable of forming the main plate 12 in order to allow this thermoforming under a temperature of less than 80° C. This constraint means that the material is thermoplastic and has a Vicat softening temperature of less than 80° C. This Vicat softening temperature, determined by the standard ISO 306:2013, method B50 using a load of 50 N and a heating rate of 50 K/h, is less than 80° C., preferably less than 70° C. and more preferably less than 65° C., but preferably greater than 45° C.

A first family of materials likely to be suitable for the production of the main plate 12 comprises thermoplastic polymer materials comprising at least one polyester of the polycaprolactone family and/or at least one polymer including polycaprolactone type macromolecular blocks.

Notably, the inventors have determined that, among the thermoplastic polymer materials that are capable of allowing thermoforming at a temperature of less than 80° C., are thermoplastic polyurethanes comprising flexible segments of the polycaprolactone copolyester type, such as the materials marketed by Lubrizol Advanced Materials, Gran Vial, 17 08160 Montmeló, Spain, under the trade name PEARLBOND®, notably grades 520 and 522.

This type of materials, comprises flexible segments including polycaprolactone type macromolecular blocks, and rigid segments, in this example comprising urethane links. The ability of these materials to be thermoformed is obtained when the flexible segments reach their melting temperature. However, at this temperature, the rigid segments retain their characteristics. Thus for this family of materials, the softening temperature at which thermoforming may be carried out will correspond to a melting temperature of the flexible segments. These materials generally have a high degree of crystallinity, and on the other hand generally exhibit a very low glass transition temperature, e.g. less than 0° C., or even less.

Other materials with similar properties may be used, such as:

Desmomelt 530, marketed by Bayer MaterialScience AG, D-51368 Leverkusen, Germany;

Biolight, marketed by Texon France SA, PO Box 226, 23 Rue De La Sarthe, 49302 Cholet, France.

A second family of materials that can be used for forming the main plate comprises amorphous or very slightly crystalline thermoplastic polymer materials, for which the softening temperature corresponds to a glass transition temperature which must therefore be within the target temperature range for thermoforming.

To make its thermoforming possible at a temperature of less than 80° C., the thermoplastic polymer material of the main plate 12, belonging to this second family of materials, preferably has a glass transition temperature of strictly less than 80° C., preferably less than 70° C. In practice, preferably materials will be chosen, the glass transition temperature of which is less than 65° C.

Preferably, in this family of materials, the thermoplastic polymer material of the main plate 12 has a glass transition temperature of greater than 45 ° C. in order to have a good rigidity in the normal conditions of use of the personal protective equipment.

The glass transition temperature will be preferably measured by differential scanning calorimetry (DSC) according to the standard ISO 11357-2:2013 with a temperature ramp of 10° C./min.

Included among the materials of this second family that may be used are:
SKYGREEN® PN200, which is a polyethylene terephthalate glycol comonomer material (PETG), marketed by SK Chemicals Co., Ltd; 686 Sampyung-Dong, Bundang-gu, Seongnam-si, Gyeonggi-do, South Korea;

Asaflex™ 830 which is a styrene/butadiene block copolymer (SBC) marketed by Asahi Kasei Corp. 1-105 Kanda Jinbocho, Chiyoda-ku, Tokyo 101-8101, Japan.
K-Resin® SBC notably grade XK40, marketed by Chevron Phillips Chemical Company LP, P.O. Box 4910, The Woodlands, Tex. 77387-4910, USA.

The main plate preferably has a thickness of between 2 mm and 5 mm, in order to confer a sufficient level of resistance against impacts while retaining a compactness and satisfactory weight for the individual intended to wear the equipment. More preferably, the thickness of the main plate 12 may be between 2.5 mm and 4 mm, notably for a material with mechanical characteristics equal to, or close to, those of PBARLBOND® 522, with, as a particular example, a main plate 12 having a thickness of 3 mm.

The first outer layer 18 consists of a textile material and is inlaid in the outer face 16 of the main plate 12 so as to create, in the outer face 16, an impression of the textile material.

The textile material of the first outer layer 18 is thus inlaid, on at least one portion of its thickness, in the outer face 16 of the main plate 12, thus ensuring an at least partial mechanical anchoring between the first outer layer 18 and the main plate 12. This mechanical anchoring preferably contributes to an adhesion between the first outer layer 18 and the main plate 12. This mechanical anchoring is particularly useful for stabilizing the interface between the first outer layer 18 and the main plate 12 at the time of thermoforming the personal protective equipment. This anchoring of the textile material in the outer face 16 of the main plate 12 also allows the main plate 12 to retain its cut shape during the shaping by thermoforming by the end user.

The first outer layer 18 is not embedded in the main plate 12 and therefore remains visible.

The inlaying of the first outer layer 18 allows a better resistance to being driven in, and delays the appearance of fracturing of the main plate 12.

Preferably, the first outer layer 18 covers the entire outer face 16 of the main plate 12. Preferably, the first outer layer 18 is inlaid in the outer face of the main plate 12 over the entire surface thereof.

In one embodiment, the first outer layer 18 is placed against the outer face 16 of the main plate by application under pressure and under a temperature higher than the softening temperature of the thermoplastic polymer material so as to create in the outer face 16, an impression of the textile material of the first outer layer 18.

The main plate 12 may be obtained by extrusion and/or calendering of the thermoplastic polymer material. In this case, the first outer layer 18 may be advantageously placed against the outer face 16 of the main plate 12 output from extrusion by a calendering operation in which the textile material of the outer layer 18 is pressed against the outer face 16 of the main plate 12 between two counter-rotating rollers, the thermoplastic material of the main plate 12 then being still in a malleable plastic state so that the pressure of calendering causes the formation of the impression of the fabric on the outer face 16.

Preferably, an adhesion is created between the first outer layer 18 and the main plate 12, which is also partly ensured by a chemical adhesion. Preferably, this chemical adhesion is achieved without adding glue between the first outer layer 18 and the main plate 12.

In the example provided, this chemical adhesion is preferably brought about by the adhesive capabilities of the thermoplastic polymer material of the main plate 12 when the latter is in the malleable plastic state above its softening temperature. Of course, the absence of glue does not prevent the fibers of the textile material constituting the first outer layer 18 from being treated with sizing for ensuring compatibility between the textile material and the thermoplastic polymer material of the main plate 12.

For the production of a personal protective element 10 according to the invention, it is possible to first create a large plate of superimposed materials, comprising a layer of thermoplastic polymer material and the first outer layer 18 made of textile material inlaid in one face of the layer of thermoplastic polymer material, and then cut a shape in this large plate of superimposed materials, following the outline 11 of the personal protective equipment 10. Thus, the main plate 12 and the first outer layer 18 have the same surface area and have overlapping edges.

Provision could be made for the textile material of the first outer layer 18 to be a non-woven textile material or a knitted textile material or a three-dimensional textile material. However, in the illustrated embodiment, the textile material of the first outer layer 18 is a woven material. A woven material, in other words a fabric, generally has warp threads parallel with each other which are intertwined with weft threads parallel with each other. In the illustrated example, the weft threads and the warp threads are arranged at 90°.

The weave of the fabric used may adopt any kind of weave generally used for fabrics, including plain weave, twill weave or satin weave, or a derivative, or a combination of these weaves. In the illustrated example, the fabric of the first outer layer 18 has a simple plain weave in which a warp thread passes alternately above and below the successive weft threads, and vice versa. For example, a 2/2 twill weave may be used.

In the illustrated example, the fabric of the first outer layer 18 is a fiberglass fabric. Each warp and weft thread therefore consists of glass fibers. However, other materials could be used. Notably, the textile fibers used for the first outer layer 18 could include fibers of carbon, aramid, polymer material such as polyamide or polyester, or even fibers of natural material such as linen, hemp or silk. Combinations of these different types of fiber may be envisaged.

The fabric used for the first outer layer preferably has a grammage of between 70 g per square meter and 450 g per square meter. For example, in the illustrated example where the fabric is a fiberglass fabric, a fabric may be chosen, the grammage of which is 200 to 400 grams per square meter, notably 300 g per square meter. For carbon or aramid fiber-based fabrics, lower grammages may be used, for example between 70 and 250 grams per square meter.

In a preferred embodiment, the first outer layer 18 is placed directly against the outer face 16 of the main plate 12, without interposing another material.

Significantly, and unlike a common use of fiberglass fabrics, the textile fibers of the first outer layer 18 are not impregnated with a rigid resin which would form a rigid composite material with the glass fibers. Rigid resin is understood to mean a resin having a longitudinal tensile Young's modulus greater than 700 MPa and a maximum elongation at break of less than 5%.

However, it may advantageously be provided to cover the first outer layer 18 with a protective layer affixed directly against the outer face of the first outer layer 18. Such a protective layer may, for example, include a polymer film, deposited, for example, by coating, and/or a membrane type preformed film, affixed with adhesion, with or without added adhesive, onto an outer face of the first outer layer 18. For example, provision may be made to deposit a polyurethane coating on the outer face of the first outer layer 18. Such a coating may, for example, be achieved by coating in the aqueous phase, notably with a doctor blade, or by spraying. The coating may be performed by immersing the textile in a bath. The coating is done on both sides, but this may allow better chemical adhesion, notably if it is a polyurethane coating.

The grammage of the outer protective layer may, for example, be between 30 g per square meter and 150 g per square meter.

The protective layer is preferably produced with a material, notably a polymer material, with a low mechanical characteristic, with a longitudinal tensile modulus of elasticity of less than 700 MPa, preferably less than 70 MPa, this in order not to hinder the shaping of the equipment 10 by thermoforming. It may, for example, be produced from an acrylic, polyethylene, or polyurethane type of material.

Preferably, this material of the protective layer will be a ductile material with a tensile elongation at break greater than or equal to 40%, preferably greater than 100%, this in order to be able to absorb the deformations of the equipment without breaking when shaped by thermoforming. The elongation at break may be determined under the conditions defined by the standard ISO 1926:2009.

Preferably, the protective layer, if it is present, covers the entire first outer layer 18.

Preferably, the first outer layer 18, or optionally the outer protective layer directly in contact with the first outer layer 18, constitutes the outermost face of the personal protective equipment 10 as a whole, in the sense that it constitutes the outermost face of the set of elements which are permanently rigidly connected to the main plate 12.

Preferably, the inner shock-absorbing layer 20 comprises a plate of cellular polymer material.

This cellular material is preferably a closed cell foam, to limit water retention, both at the time of thermoforming and in use.

This cellular polymer material is preferably an elastic, more preferably an elastomeric material. Preferably, such a material has a resilience by ball rebound determined according to the standard ISO 8307:2007, greater than 20%, preferably greater than 30%. By way of example, the cellular polymer material may be a cellular material based on ethylene-vinyl acetate (EVA), e.g. a product marketed by PRIMACEL, ZI DES BELLEVUES, 35 AV DU GROS CHENE, 95220 HERBLAY, France, under the trade name EVALASTIK®, notably grades 25, 30, 35, 40 or 45.

The inner shock-absorbing layer 20, may consist of multiple layers of superimposed cellular polymer materials, notably multiple layers of cellular polymer materials having different mechanical properties. The various layers are then preferably assembled to form a complex.

The inner shock-absorbing layer 20 may have, at least in a central portion, a thickness of between 3 mm and 8 mm.

The inner shock-absorbing layer 20 may have a grooving on its inner face 21, and/or micro-perforations, for the purpose of improving comfort in use, notably by improving the drainage of perspiration and/or by improving ventilation. A grooving may comprise a series of parallel grooves made in the inner face 21. The grooves preferably have a shallow depth, e.g. less than or equal to 2 mm, or even less than or equal to 1 mm, and preferably a small width, e.g. less than or equal to 2 mm or even less than or equal to 1 mm. The grooving may be achieved by removing material, e.g. by laser. The inner shock-absorbing layer 20 may be treated with an antimicrobial agent, notably an antibacterial agent.

Preferably, the inner shock-absorbing layer 20 covers the entire inner face 14 of the main plate 12. Preferably, the inner shock-absorbing layer 20 is glued, by its outer face 19, onto the inner face 14 of the main plate 12, e.g. by means of an adhesive film or a glue, e.g. a neoprene glue. Preferably, the gluing is carried out over the entire surface of the inner face 14 of the main plate 12. In some embodiments, the inner shock-absorbing layer 20 may overhang the peripheral edge of the main plate 12, over all or part thereof. The overhang of the inner shock-absorbing layer 20, with respect to the peripheral edge of the main plate 12, may be a few millimeters, notably 1 mm to 10 mm, e.g. between 2 mm and 6 mm, to mitigate any possible excess pressure at the peripheral edge of the main plate 12 in contact with the limb during use.

In some embodiments, such as that illustrated, the inner shock-absorbing layer 20 constitutes the innermost face of the personal protective equipment 10, in the sense that it constitutes the innermost face of the set of elements which are permanently rigidly connected to the main plate 12. However, as a variant, provision may be made to attach an inner interface layer (not represented), on an inner face 21 of the inner shock-absorbing layer 20. Such an inner interface layer will preferably have a limited thickness, e.g. less than 1.5 mm. It may have a function of comfort and/or a function of adhesion.

The main plate 12 has a peripheral edge which, as in the example illustrated in FIG. 2, may coincide with the outline 11 of the equipment 10.

The equipment according to the invention may advantageously be provided with a bias 22 which is added astride the peripheral edge. Thus, the bias 22 covers not only the edge of the main plate 12 but also a peripheral portion of the inner and outer faces 14, 16, e.g. over a distance of between 5 and 15 millimeters inward from the outline 11.

The bias 22 may be made in the form of a strip of material, initially flat, folded astride the peripheral edge of the main plate 12. Such a strip of material may comprise a strip of textile material, notably woven. The strip of material may optionally include, on at least one outer face, a coating having a greater coefficient of adhesion than that of the underlying textile material, this notably in order to help the personal protective equipment 10 to be correctly held in place when in use.

The bias 22 may be made in the form of a molded polymer material, preferably a material having a greater coefficient of adhesion than that of the inner shock-absorbing layer 20, or covered with such a material. Such a bias 22 may be made, for example, of elastomeric material, such as silicone, polyurethane, styrene butadiene, and/or SBS [poly (styrene-b-butadiene-b-styrene)], and/or SEBS [polystyrene-b-poly (ethylene-butylene)-b-polystyrene]. Such a bias 22 may be previously molded, to the shape of the outline 11 of the personal protective equipment 10 then added onto the outline 11 of the personal protective equipment 10. Alternatively, it may be molded directly onto the outline 11 of the equipment 10.

In any case, it may be provided that the bias 22 be sewn with a seam passing through the main plate 12, over all or part of the peripheral edge of the main plate 12 perpendicular to its inner and outer faces. In the embodiments in which the first outer layer 18 and the inner shock-absorbing layer 20 both extend over the entire surface of the main plate 12, these three elements therefore having superimposed peripheral edges, the bias 22 is preferably added astride the peripheral edges of these three elements, as seen notably in FIG. 2. Regardless of the method for attaching the bias 12, e.g. by gluing and/or by sewing and/or by molding, such an arrangement will make it possible not only to conceal the peripheral edge of these elements, but also to avoid any risk of separation between the main plate 12 and, on the one hand, the first outer layer 18 and, on the other hand, the inner shock-absorbing layer 20.

FIG. 2A illustrates the implementation, in the peripheral edge of the inner shock-absorbing layer 20, of a recess 24 for housing the corresponding part of the bias 22, this in order to limit or even prevent the bias becoming excessively thick with respect to the inner face 21 of the inner shock-absorbing layer 20. At the recess 24 the inner shock-absorbing layer 20 therefore has a reduced thickness. Such a recess 24 may be created by local deformation of the material or by removal of material, e.g. by milling or by laser ablation.

The protective equipment 10 according to the invention is devoid of any element which, by its flexural stiffness, would resist it being thermoformed, notably at the thermoforming temperature of less than 80° C. Thus, the protective element 10 is thermoformable, at the thermoforming temperature of less than 80° C., as a whole, including all the elements that are permanently rigidly connected to the main plate 12. In the illustrated example, the protective equipment 10 as a whole consists of the main plate 12, the first outer layer 18, the inner protective layer 20, and, if they are present, the outer protective layer and the bias 22. It is noted, for example, that the fabric forming, in the embodiment, the first outer layer 18 comprises glass fibers which exhibit a high tensile Young's modulus. However, the grammage of this fabric is such that its intrinsic stiffness is low, and its implementation, in which it is not embedded in a rigid resin, results in it not forming a stiff structure which would resist the thermoforming of the protective element 10 as a whole.

The invention therefore provides an item of personal protective equipment which can be shaped by the user without the intervention of a specialist technician and without tools specifically dedicated to this shaping, therefore at a lower cost.

The invention is not limited to the examples described and represented since various modifications may be applied thereto without departing from its scope.

1. Personal protective equipment (10) intended to protect a limb of an individual, comprising:
a main plate (12) of thermoplastic polymer material having two opposing faces, respectively an outer (16) and an inner (14) face;
a first outer layer (18) placed next to the outer face (16) of the main plate (12);
an inner shock-absorbing layer (20) arranged on the side of the inner face (14) of the main plate (12);
characterized in that:
the first outer layer (18) consists of a textile material and is inlaid in the outer face (16) of the main plate (12) so as to create, in the outer face (16), an impression of the textile material.

2. The personal protective equipment according to claim 1, characterized in that the first outer layer (18) is applied against the outer face (16) of the main plate (12) by application under pressure and under a temperature sufficient to create an impression of the textile material in the outer face (16).

3. The personal protective equipment according to claim 1, characterized in that the textile material of the first outer layer (18) is a woven material.

4. The personal protective equipment according to claim 1, characterized in that the textile material of the first outer layer (18) is a fiberglass fabric.

5. The personal protective equipment according to claim 1, characterized in that the first outer layer (18) is covered, on an outer face opposite an inner face inlaid in the outer face of the main plate, with a polymer film.

6. The personal protective equipment according to claim 5, characterized in that the grammage of the polymer film is less than 250 grams per square meter, preferably less than or equal to 150 grams per square meter.

7. The personal protective equipment according to claim 5, characterized in that the polymer film is deposited by coating.

8. The personal protective equipment according to claim 5, characterized in that the polymer film is a preformed film affixed with adhesion to the outer face (16) of the first outer layer (18).

9. The personal protective equipment according to claim 1, characterized in that the thermoplastic polymer material of the main plate (12) is thermoformable at less than 80° C.

10. The personal protective equipment according to claim 1, characterized in that the equipment (10) is capable of being shaped by passing from a first stable geometric configuration of the equipment (10), to a second stable geometric configuration of the equipment (10), distinct from the first, by heating by means of liquid hot water only, by applying a shaping force then by cooling.

11. The personal protective equipment according to claim 10, characterized in that the equipment (10) is capable of being successively shaped multiple times.

12. The personal protective equipment according to claim 1, characterized in that the thermoplastic polymer material of the main plate (12) may have a Vicat softening temperature, determined by the standard ISO 306:2013, method B50 using a load of 50 N and a heating rate of 50 K/h, which is less than 80° C., preferably less than 70° C. and more preferably less than 65° C., but preferably greater than 45° C.

13. The personal protective equipment according to claim 1, characterized in that the thermoplastic polymer material of the main plate (12) comprises at least one polyester of the polycaprolactones family and/or at least one polymer including polycaprolactone type macromolecular blocks.

14. The personal protective equipment according to claim 1, characterized in that the thermoplastic polymer material of the main plate (12) comprises a thermoplastic polyurethane including flexible segments of the polycaprolactone copolyester type.

15. The personal protective equipment according to claim 1, characterized in that the main plate (12) has a thickness of between 2 mm and 5 mm, preferably between 2.5 mm and 4 mm.

16. The personal protective equipment according to claim 1, characterized in that the inner shock-absorbing layer (20) comprises a plate of cellular polymer material.

17. The personal protective equipment according to claim 1, characterized in that the main plate (12) has a peripheral edge and in that a bias (22) is added astride the peripheral edge.

18. The personal protective equipment according to claim 17, characterized in that the bias (22) is sewn by a seam that passes through the main plate perpendicular to its inner and outer faces.

19. The personal protective equipment according to claim 17, characterized in that the bias (22) is a molded part.
